(19) United States
(12) Patent Application Publication
(10) Pub. No.: US 2014/0218005 A1
(43) Pub. Date: Aug. 7, 2014

(54) ANODE DEPLETION SENSOR HARDWARE CIRCUIT

(71) Applicant: GENERAL ELECTRIC COMPANY, Schenectady, NY (US)

(72) Inventor: Brett Alan Farris, Louisville, KY (US)

(73) Assignee: GENERAL ELECTRIC COMPANY, Schenectady, NY (US)

(21) Appl. No.: 13/760,321

(22) Filed: Feb. 6, 2013

(51) Int. Cl. G01N 17/02

(52) U.S. Cl. CPC G01N 17/02
USPC 324/71.2

(57) ABSTRACT

The present subject matter relates to systems and methodologies for providing anode rod depletion detection and warnings thereof to consumers. Consumers generally are not concerned with monitoring consumption of protective anode rods incorporated within water heaters. The present subject matter provides automatic monitoring of anode rod depletion and provides the consumer with notification of rod depletion beyond a predetermined amount by one or more of optical, audible, or electronic devices.

### FIELD OF THE INVENTION

The present subject matter relates to appliance protection functionality. More specifically, the present subject matter relates to systems and methodologies for providing anode rod depletion sensor circuitry for water heaters.

### CROSSREFERENCE TO RELATED APPLICATIONS

The present subject matter is related to GE docket #264099 entitled “Anode Depletion Sensor Algorithm” filed concurrently herewith, assigned to the owner of the present subject matter, and incorporated herein for all purposes.

### BACKGROUND OF THE INVENTION

Passive anode rods are a vital component to water heaters utilizing a steel tank. This sacrificial anode rod provides protection against tank corrosion through galvanic corrosion. The anode rod creates a galvanic current following between the anode and the cathode (the water heater tank) which it is electrically connected. The depletion of the anode rod caused by this galvanic circuit can be calculated by measuring this electric current value and knowledge of the anode rod properties. The measurement circuit components and algorithm used to measure the depletion of a water heater anode rod must be carefully selected to minimized introduced error. This paper describes the circuit and system tolerance stack-up to achieve accurate measurement of the anode rod depletion status.

### BRIEF DESCRIPTION OF THE INVENTION

Aspects and advantages of the invention will be set forth in part in the following description, or may be apparent from the description, or may be learned through practice of the invention.

The present subject matter relates to a water heater anode rod depletion sensor circuit. According to such circuit, an anode rod current sensor circuit, and a controller are configured so that the controller receives a signal indicative of anode rod current flow from the current sensor circuit and provides an output signal to an indicator configured to provide an indication of anode rod depletion based.

The present subject matter also relates to a method of alerting a consumer upon depletion of a water heater anode rod. According to such method current flow through the anode rod is monitored. The method then provides for evaluating the current flow to determine anode rod depletion and issuing an alert when anode rod depletion reaches a predetermined amount.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a block diagram of an anode protection system in accordance with the present subject matter;

FIG. 1A illustrates an exemplary operational amplifier and shunt resistor circuit usable with the system of FIG. 1;

FIG. 2 provides a chart of exemplary anode depletion measurement factors for consideration when constructing sensor hardware circuitry in accordance with the present subject matter;

FIG. 3 provides a chart illustrating exemplary tolerance and error details for sensor hardware circuits constructed in accordance with the present subject matter;

FIG. 4 provides a graphical representation of operational current flow in an exemplary circuit constructed in accordance with the present subject matter;

FIG. 5 provides a graphical representation of anode rod depletion tolerances applicable to the present subject matter; and

FIG. 6 provides a graphical representation of galvanic current effects on anode rod life.

Repeat use of reference characters throughout the present specification and appended drawings is intended to represent same or analogous features or elements.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

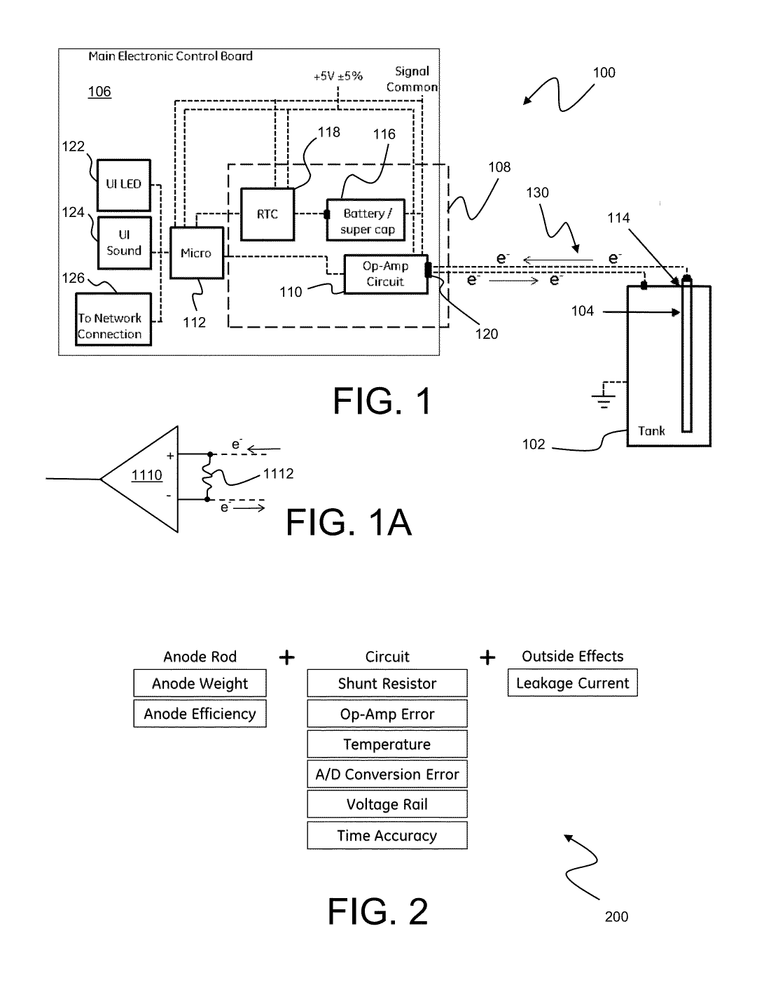

As previously noted, the present subject matter relates to systems and methodologies for providing anode rod depletion sensor circuitry for water heaters. With present reference to FIG. 1 there is illustrated a block diagram of an anode protection system 100 in accordance with the present subject matter. Anode protection system 100 corresponds to two major components including a water heater 102 together with its internally mounted anode rod 104 and a main electronics control board 106 including, among other sub-components, anode depletion circuit 108.

In this configuration a passive anode rod 104 is connected to the steel tank of water heater 102 through an anode depletion circuit 108. A galvanic circuit is formed from the connection to the steel tank in which anode rod 104 depletes preferentially to the steel tank.

Using Faraday's Laws of Electrolysis a calculation can be made by measuring the current over time created by the electrons moving from the anode (anode rod 104) to the cathode (the steel tank of water heater 102). The current flow can be calculated using Equation 1 below wherein the specific anode rod material properties and a measurement of the anode rod mass is removed.

$$m = ( \frac{Q}{F} ) ( \frac{M}{z} ) \times Eff \qquad Eq . 1$$

Wherein: m=mass of material removed due to electrolysis
Q=total electric charge passed through the material

$$F = 96 , 485 \frac{C}{mol} ,$$

Faraday's Constant
M=molar mass of the material
z=electrons in each ion transfer
Eff=Anode Rod efficiency value

In order to measure Q, a modification must be made to the anode-cathode electrical connection as illustrated in FIG. 1. The circuit configuration causes the anode rod 104 electrons (current) to travel through a current sense resistor 1112 as illustrated in FIG. 1A as part of the Operational Amplifier (op-amp) Circuit 110, further illustrated as op-amp 1110 of FIG. 1A. In order to measure this current flow, anode rod 104 must be isolated from the water heater tank at its mounting location, for example by use of isolating insulation, indicated on FIG. 1 as Insulated Cap 114.

In accordance with the present subject matter, the main electronic control board 106 comprises microcontroller 112, power supply 116, current measurement operational amplifier 110, real-time clock 118 (or other means of retrieving accurate time such as via an Internet clock accessed through network connection 126), and various connections to the water heater anode rod representatively illustrated as connector 120. Microcontroller 112 receives inputs from operational amplifier 110 and real time clock 118. It should be appreciated that microcontroller 112 may correspond to other types of controllers including a microprocessor or other specially designed hardware and thus the designation as a microcontroller should be broadly interpreted. Microcontroller 112 is configured to perform calculations and make decisions based on an anode rod depletion algorithm, and to then provide consumer feedback by way of one or more of a User Interface (UI) display 122, UI sound producing device 124, or by way of connected home appliance communication by network connection 126.

In accordance with the present subject matter, op-amp circuit 110 incorporates a current sensing resistor 1112 (FIG. 1A) and operational amplifier 1110 to amplify a voltage produced across the current sensing resistor 1112 by current flow in the anode-cathode path generally illustrated as path 130. In an exemplary configuration, such amplified voltage may provide a 0-5V signal corresponding to a gain of 50V/V. In this way the current sensing resistor may correspond to a very small resistive value, for example, about 1.91 Ω, and thereby minimize interference to the galvanic current flow of the system.

Those of ordinary skill in the art will appreciate that although the use of a small resistance is advantageous for the galvanic circuit such use generally requires the use of a more precise op-amp circuit. Alternative configuration can be employed, however, by using a corrosion probe such as a silver-chloride probe that generates a voltage corresponding to the level of protection provided by the anode rod. As is understood by those of ordinary skill in the art, a voltage of a specific level or higher is an indication that the tank is being protected by the galvanic circuit. As the current sensing resistor value is increase the voltage reading will decrease and thereby a suitable resistor value can be chosen.

Real-Time Clock (RTC) 118 provides an accurate time stamp for the microcontroller when requested by, for example, an operational algorithm. Advantages obtained through the inclusion of RTC 118 are discussed further hereinafter with regard to a discussion of circuit tolerances. RTC 118 may be powered by battery 116 so that the correct time is maintained. In alternative configurations battery functionality may be provided by a super capacitor. In further alternative embodiments, a thermal energy harvesting circuit can be implemented to provide sufficient energy to keep RTC 118 powered during periods when power is removed from the water heater. A thermal energy harvesting method can utilize the heat from an electric water heater tank or the ignition/main flame from a gas water heater to provide power to the circuit. In alternative embodiments a super capacitor's ability to recharge when external power is available to the control board is advantageous over use of a standard battery. It should also be appreciated that a rechargeable battery may also be employed in a manner similar to rechargeable super capacitors.

Microcontroller 112, like other control boards serves to receive inputs, in this case, from the op-amp circuit 110 and RTC 118 and perform operations. It should be appreciated that the present subject matter is directed more specifically to a sensor circuit configured to provide an indication of anode rod depletion to a consumer. In that regard, particular algorithms executed by microcontroller 112 are not a part of the present subject matter but generally it will be understood that the algorithm is designed to evaluate the condition of anode 104 so as to determine its state of depletion while at the same time minimizing errors as well as minimizing false negative and false positive detection of a depleted anode. An exemplary specific algorithm that may be incorporated with the present subject matter has been described in a related US patent application based on GE docket #264099 entitled “Anode Depletion Sensor Algorithm” filed concurrently herewith, assigned to the owner of the present subject matter, and incorporated herein for all purposes.

With present reference to FIG. 2, there is provided a chart 200 of anode depletion measurement tolerance factors that should be kept in mind when constructing a sensor hardware circuit in accordance with the present subject matter. A general objective of a system constructed in accordance with the present subject matter is to alert the consumer when the anode rod 104 is depleted to a certain level. Through consideration of the various tolerance factors, this certain level can be defined. Once implemented, care should be taken that the customer not be alerted too early when there is still usable anode life remaining. On the other hand, neither should the system delay alerting the customer until after the anode is too depleted to serve its corrosion protection function. In order to address these concerns, consideration should be given to the various tolerance errors illustrated in FIG. 2 including those introduced by the anode rod per se, the electronic circuit, and outside effects.

With continued reference to FIG. 2, it is noted that anode rod tolerances errors may be introduced from consideration of the anode weight and efficiency. Circuit tolerance errors may be introduced from consideration of not only the shunt resistor value and op-amp errors as previously noted, but also temperature, analog to digital (A/D) conversion errors, voltage rail (supply) errors, and time accuracy of RTC 118. Of course outside errors may also be introduced from such as leakage currents variously introduced into the system.

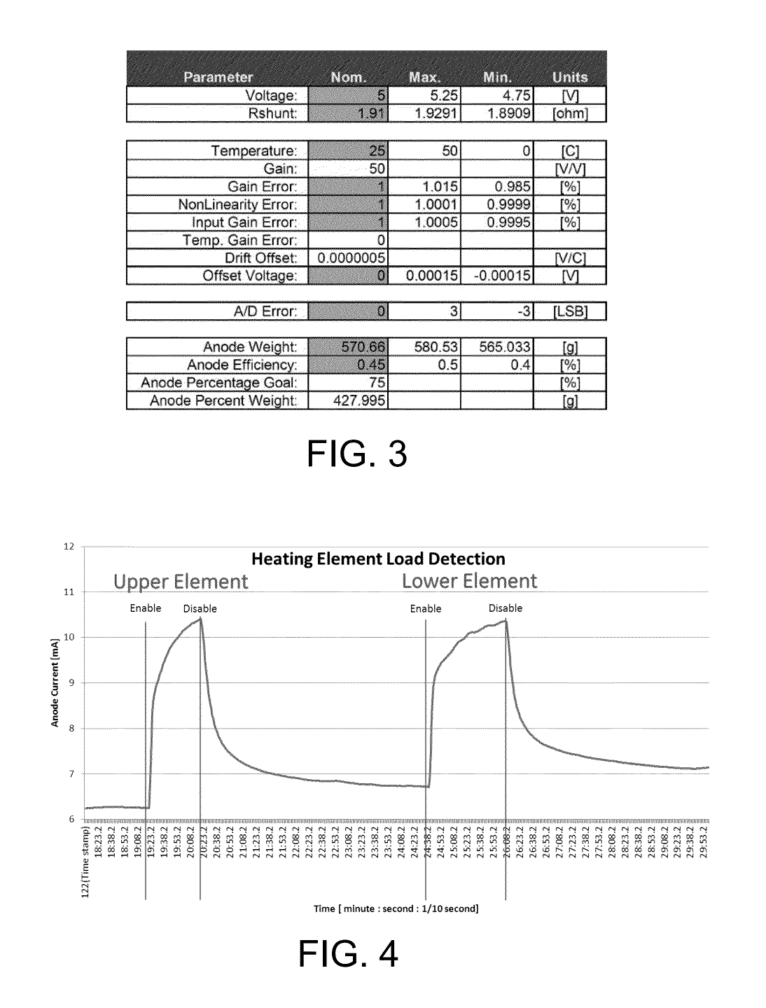

The dimension and mass properties of anode rod 104 can be controlled through manufacturing means, although those are properties have not previously been of specific concern to manufactures. Likewise, anode efficiency can be controlled through controlled formation of the anode as well as appropriate selection of their material composition. FIG. 3 is a chart illustrating exemplary tolerance and error details for sensor hardware circuits constructed in accordance with the present subject matter. With reference to the exemplary values illustrated in FIG. 3, the variation in anode dimensions and mass were determined based on presently available water heater production anode rods. The illustrated exemplary variation in efficiency was determined through empirical data gathered through field test studies.

With continued reference to FIGS. 1 and 1A, the anode depletion circuit 108 can be considered to be divided into two parts. The first part of the circuit, the current measurement circuit, utilizes a differential operational amplifier 110, 1110 to amplify the voltage across a current measurement (shunt) resistor 1112. Because the galvanic current is inversely correlated to the resistance between the anode and cathode the resistor will need to be as small as possible. The op-amp itself can be a discrete circuit or a high accuracy Integrated Circuit (IC) which includes precise resistors to minimize variation. Temperature variation, op-amp error, resistor tolerance, and microcontroller A/D error all play important roles in the overall tolerance considerations. Op-amp error can include Non-linearity, input gain, temperature gain, drift offset, and offset supply voltage error. These variations are illustrated in FIG. 3.

The second part of the hardware circuit addresses the issue of keeping an accurate time of operation. A Real-Time Clock (RTC) 118 with battery backup 116 is used to keep accurate time of the water heater life through power ON and power OFF scenarios. RTC 118 and battery backup 116 can be implemented through means of a discrete RTC and battery or a RTC integral to the control board microcontroller which has capability of a battery backup either by a dedicated pin or independent circuitry. Because the Q factor of Eq. 1 is dependent on time the battery backup provides significant functionality due to unstable power conditions. Many water heaters will experience significant power OFF time due to weather and utility work. In addition many consumers use timers to only power their water heater certain times of the day or power OFF their water heater when they are away from a vacation house. Without RTC 118 and battery back-up 116 the duration and value of the galvanic current is unknown when power if OFF. Because the water heater can be in the power OFF state between 1% and 50% of the life cycle this unknown becomes the single biggest source of error in the anode depletion calculation.

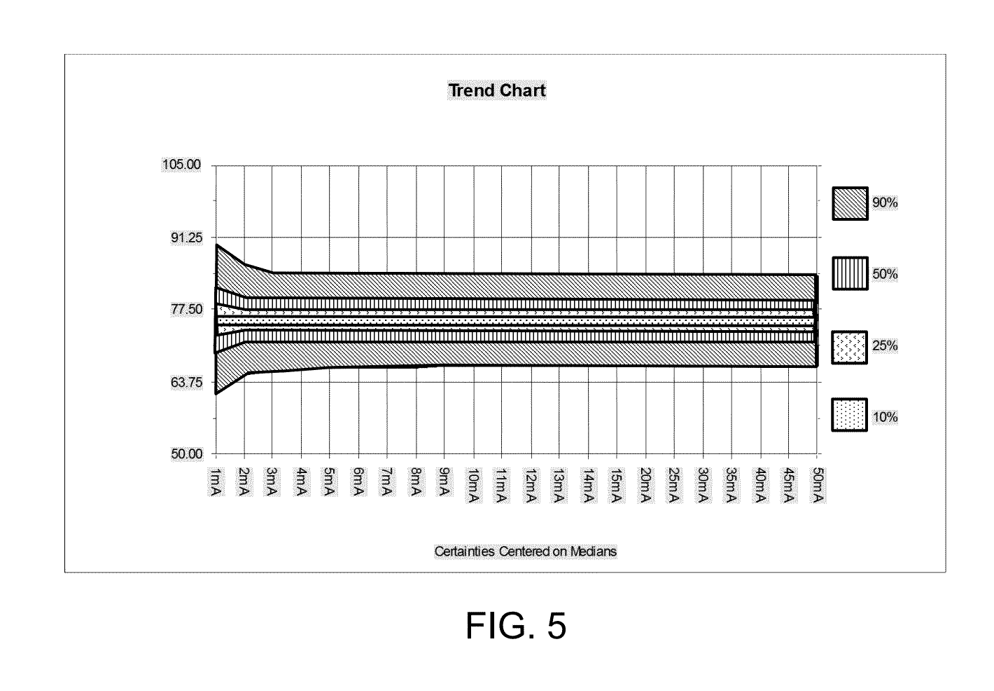

With reference to the parameters and values illustrated in FIG. 3 overall tolerance can be calculated factoring in each variable and the tolerance or error associated with it. A graph of an exemplary tolerance stack-up across the currents of interest is illustrated in FIG. 5. In an exemplary configuration, the goal depletion status shown is 75% of the original anode rod weight excluding the cap and core wire. This goal status will be adjustable depending of system environment and status. The low end increased variation is due to the greater affect current has of the depletion of the anode rod. As the current rises, variation in current of +/−1 mA has much less affect than at low current measurements. FIG. 5 is helpful in understanding the impact of the low current variation.

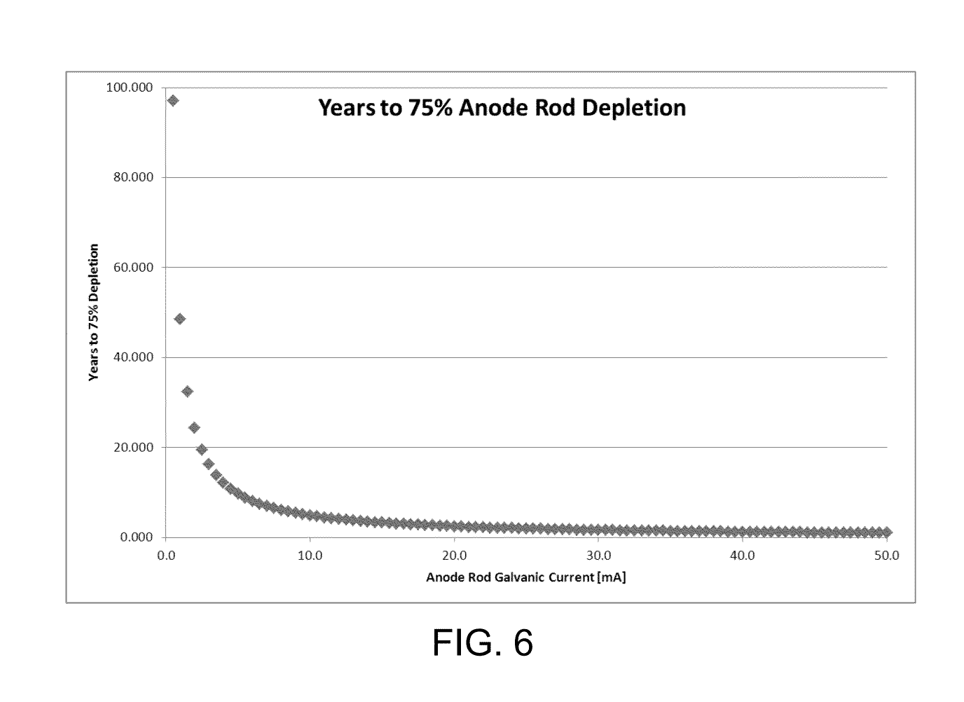

With present reference to FIG. 6, the average time to 75% anode rod depletion is illustrated in years. Conventional practice is to recommend that an anode rod be replaced at minimum every 10 years. Taking this into account an average anode rod galvanic current lower than 4.5 mA will not be applicable. This means that even though a system constructed in accordance with the present subject matter has increased variation below 4.5 mA the measurement system will not affect reliability because the algorithm will warn the consumer to replace their anode at 10 years.

Through consideration of part tolerances, errors, and variability in the galvanic current measurement system an accurate estimate of the anode rod depletion status can be determined The benefits of this are twofold. First, for the consumer, a reliable indication of the anode rod life is available without manually removing the anode rod and inspecting. Second, for the supplier, this allows for reduced risk of water heater leaks. Nearly 99% of all people will not check their water heater anode rod. By alerting the consumer through UI LED, UI audible noise and home energy management (HEM) notification water heaters under warranty will have a lower failure rate due to corrosion. Water heater tank failure due to anode rod depletion is a leading cause of warranty replacement. This feature makes it easy for the consumer to protect their water heater tank and allows for accountability of the consumer to maintain their unit.

It should be understood by those of ordinary skill in the art that while the present subject matter has been described in relation to network enabled appliances, such subject matter is equally applicable to any appliance, whether network enabled or not, with which communications with a consumer is desirable.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A water heater anode rod depletion sensor circuit, comprising:
an anode rod current sensor circuit;
a controller configured to receive a signal indicative of anode rod current flow from said current sensor circuit and to provide an output signal based on said signal indicative of anode rod current flow; and
an indicator configured to provide an indication of anode rod depletion based on said output signal.

2. A circuit as in claim 1, wherein said anode rod current sensor circuit comprises an operational amplifier and a shunt resistor.

3. A circuit as in claim 2, wherein said operational amplifier is a differential operational amplifier and said shunt resistor is couple across differential inputs thereof

4. A circuit as in claim 2, wherein said shunt resistor is configured to be connected at one end to a water heater anode rod and at the other end to a water heater tank,

5. A circuit as in claim 1, further comprising:
a real time clock configured to provide time signals, wherein said controller is further configured to receive said time signals and to provide an output signal based thereon.

6. A circuit as in claim 5, further comprising:
a power supply coupled to said real time clock.

7. A circuit as in claim 6, wherein said power supply comprises one of a backup battery, a rechargeable battery, a capacitor, and a beat source and thermoelectric generator.

8. A circuit as in claim 1, wherein said indicator comprises one or more of a visual, audible, and electronic device

9. A circuit as in claim 8, wherein said indicator comprises one or more of a light emitting diode (LED) and a sound source.

10. A circuit as in claim 8, wherein said electronic device comprises a network enabled device,
whereby indications of anode rod depletion may be sent to a remote location.

11. A method of alerting a consumer upon depletion of a water heater anode rod, comprising:
monitoring current flow through the anode rod;
evaluating the current flow to determine anode rod depletion; and
issuing an alert when anode rod depletion reaches a predetermined amount.

12. A method as in claim 11, wherein monitoring current flow comprises monitoring voltage across a shunt resistor from current flow there through from the anode rod.

13. A method as in claim 12, wherein monitoring voltage comprises monitoring the output of a differential operational amplifier whose inputs are coupled to the shunt resistor.

14. A method as in claim 11, further comprising:
monitoring time during which current flows through the anode rod, wherein evaluating comprises evaluating the current flow and time.

15. A method as in claim 14, wherein monitoring time comprises monitoring real time.

16. A method as in claim 15, wherein monitoring real time comprises monitoring time with a power supply backed up time source.

17. A method as in claim 11, wherein issuing an alert comprises one or more of issuing a visual, audible, and electronic alert.

18. A method as in claim 17, wherein issuing an alert comprises one or more of activating a light emitting diode (LED) and a sound source.

19. A method as in claim 17, wherein issuing an electronic alert comprises issuing an alert through a network enabled device.
